(19) United States
(12) Patent Application Publication
(10) Pub. No.: US 2020/0155398 A1
(43) Pub. Date: May 21, 2020

(54) ROTATING SUPPORT STRUCTURE WITH RELEASE PEDAL

(71) Applicant: Bobby L. Hawkins, Travelers Rest, SC (US)

(72) Inventor: Bobby L. Hawkins, Travelers Rest, SC (US)

(21) Appl. No.: 16/516,909

(22) Filed: Jul. 19, 2019

Related U.S. Application Data
(60) Provisional application No. 62/700,964, filed on Jul. 20, 2018.

(51) Int. Cl. A61G 7/10

(52) U.S. Cl. CPC A61G 7/1038; A61G 7/1098; A61G 7/1076; A61G 7/1069

(57) ABSTRACT

A rotating support stand for an individual with limited mobility is provided in which a pivoting base supports a platform. The base and platform are able to pivot when a release pin that is actuated by a pedal is disengaged from the platform. Following a rotation of the platform, the pin will engage into a locked position and allows the individual supported on the platform to be in a new second position.

### RELATED APPLICATIONS

This application claims the benefit of U.S. Application Ser. No. 62/700,964 filed on Jul. 20, 2018 and which is incorporated herein by reference.

### FIELD OF THE INVENTION

This invention is directed towards a rotating support platform that has various locking positions that can be released via a foot pedal so as to rotate the platform to a new and locked position. The invention is particularly useful for assisting patients who need assistance in turning when getting in and out of a bed, a chair, or wheelchair. In addition, the invention has further utility with respect to positioning heavy objects that may need turning or rotating in order to facilitate use or access to the object.

### BACKGROUND OF THE INVENTION

This invention relates to support platforms and rotating platform that are designed to pivot. Such platforms are known in the medical field to assist with patients that may need help turning in order to get in or out of a bed, chair or wheelchair. While a number of such devices are available in the marketplace, there remains room for variation and improvement within the art. One such prior art, support platform can be seen in reference to U.S. Pat. No. 7,191,477 directed to a medical assist device and which is incorporated herein by reference in its entirety for all purposes.

### SUMMARY OF THE INVENTION

It is one aspect of at least one of the present embodiments of the invention to provide a rotating support structure and a process of using the support structure comprising a base; a pivot supported by the base and in further communication with a platform, the platform supported by an upper surface of the pivot; a pedal secured within the base and coupled to a release pin that extends above the base, the pin being adapted to engage an aperture defined by the platform; wherein when the pedal is actuated, the pin disengages from the aperture allowing the platform to rotate and the pin thereafter engaging a second aperture within the platform thereby securing the platform into a locked positioned.

It is a further aspect of at least one embodiment of this invention to provide for a process of positioning an individual on a support structure comprising the steps of: a rotational support having a base; a pivot supported by the base and in further communication with a platform, the platform supported by an upper surface of the pivot; a pedal secured within the base and coupled to a release pin that extends above the base, the pin being adapted to engage an aperture defined by the platform; wherein when the pedal is actuated, the pin disengages from the aperture allowing the platform to rotate from a first position and the pin to thereafter engage a second aperture within the platform thereby securing the platform into a locked positioned; engaging the pedal to release a pin; turning the base from a first position to a second position, as the pedal is actuated, allowing the platform and individual to be rotated to a second position in which the platform is locked, thereby enabling a person supported on the stand to be removed, from the stand in a different orientation.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1A is an exploded view of a base and pivot portion of a rotating support structure according to one aspect of the present invention.

FIG. 1B is an enlarged view of a deal release mechanism.

FIG. 2 is an exploded bottom view of the base and pivot structure and pedal structure according to one embodiment of the present invention.

FIG. 3 is a view of the components of the pedal portion that is used to engage and disengage the pivot portion of the base.

FIG. 4 is a perspective view showing an exemplary handle that can be utilized with the support structure.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

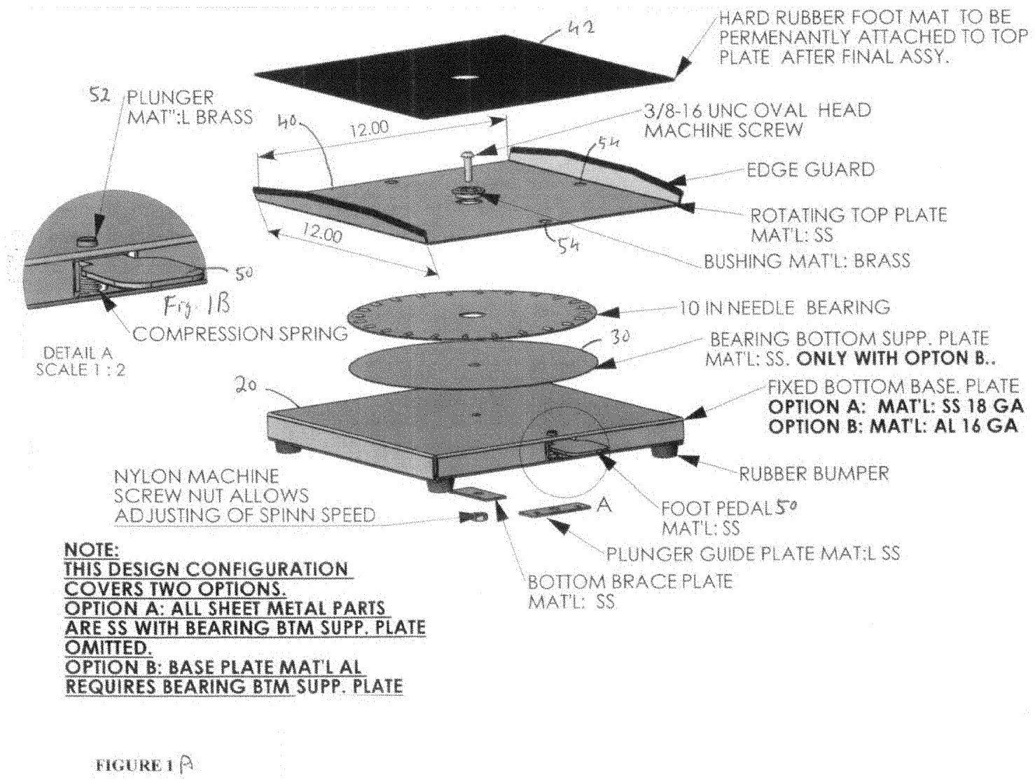

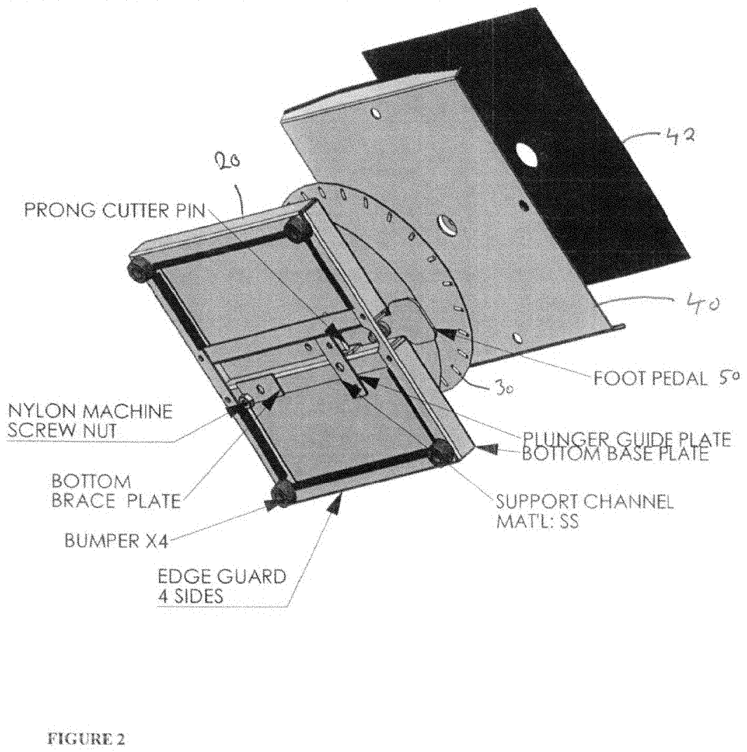

As seen in reference to FIG. 1A the support apparatus 10 has a bottom base 20 which supports one or more various embodiments of a pivoting member 30 which can be seen in the form of a circular plate supported by bearings or a circular plate having needle bearings. The type of pivoting member can vary depending upon the weight and strength of materials being utilized in the base member 20.

Supported above the pivoting member 30 is a support plate 40 which is designed to support a heavy article including a person. Optionally, a rubber mat 42 can be provided to provide a high coefficient of friction surface for applications where an individual may stand on the platform. The base is in operative communication with a foot pedal 50, also seen in FIG. 1B that is accessible along one edge of the base 20 and which is coupled to a spring loaded pin 53 that extends through an upper surface of the base and is adapted for engaging with one or more of the plurality of apertures 54 defined in the upper support plate. The pin 52 engages the support plate apertures 54 to lock the support plate into a fixed position until such time as the pedal is depressed and the pin is released. Upon rotation of the top platform, the spring, biased pin 52 will engage the next available aperture thereby locking the support platform into a fixed position.

The upper support plate 40 can have any number of apertures 54 present. For instance, as illustrated, four apertures can be positioned on opposite edges of the support plate such that the support plate can rotate 90 degrees when disengaged and reengages the next adjacent aperture. However, it is recognized that the number of apertures and the position of the apertures can be varied to accommodate any desired degree of rotation of the support platform relative to the base.

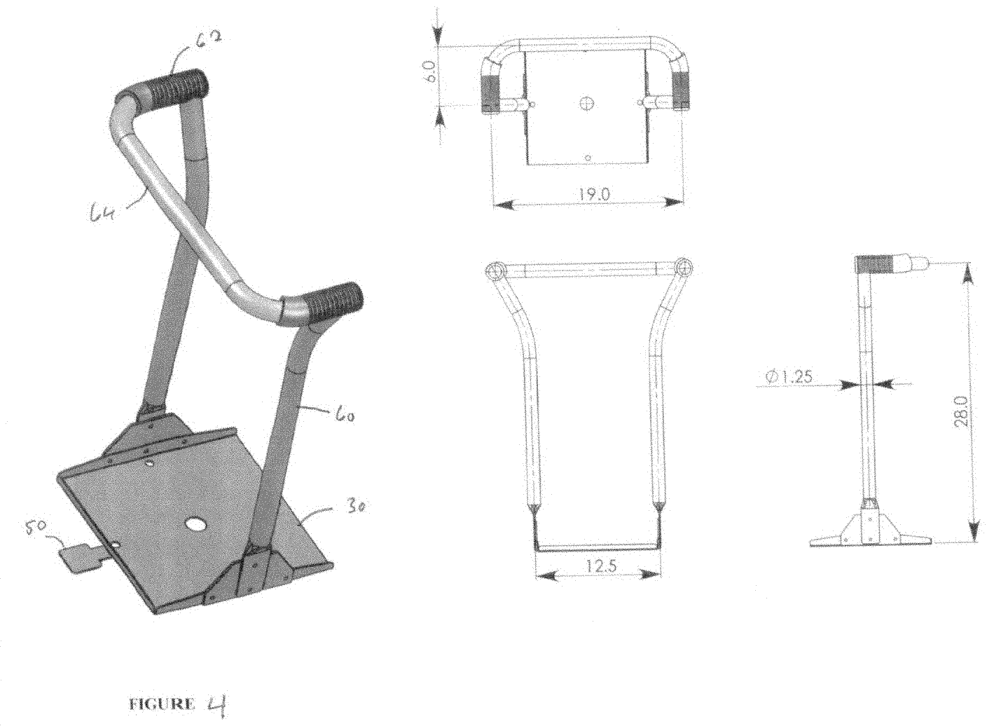

As best seen in reference to FIG. 4, a handle 60 can be provided which is attached on opposite edge walls of the pivoting platform and has vertically extending legs 62. As illustrated, the legs have a slight bend which allows for a horizontal grip portion 64 to be placed along an upper terminus of the legs 62. A interconnecting piece 66 extends from and connects the opposing pair of handles that allow a user to support themselves when standing on the pivoting platform.

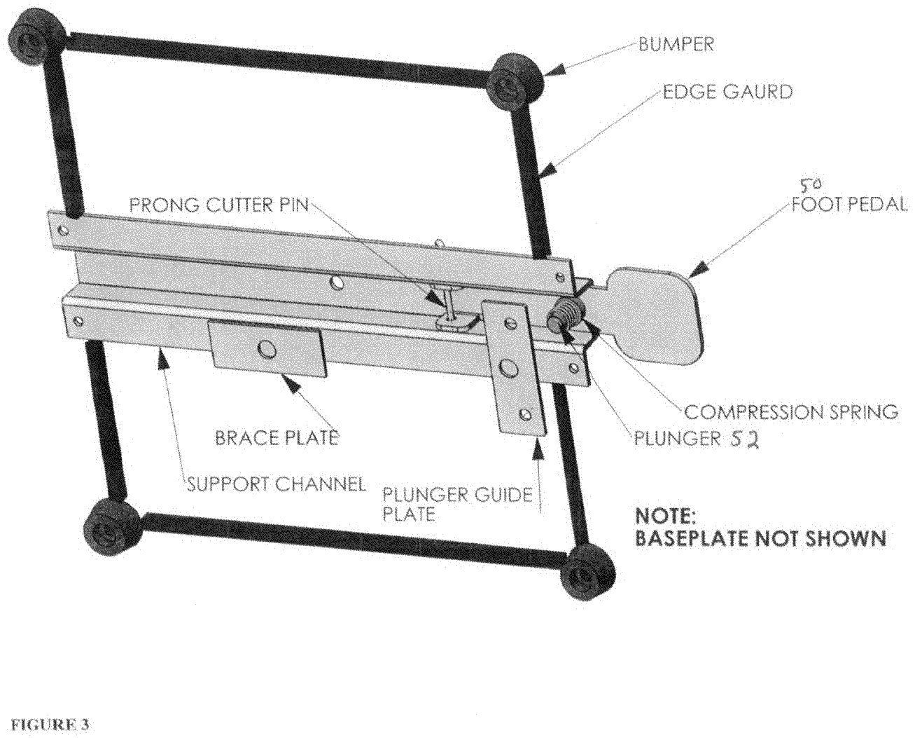

As seen in reference to FIG. 1A, the base 20 can have supported thereon a pivoting member 30 which can utilize any number of conventional support mechanisms that would allow rotation of the pivoting member 30 relative to the lower base 20 and the upper support plate 40. Such components could include the use of roller bearings or needle bearings to allow the pivoting member 30 to be supported and allowed to rotate. The rotation of supporting member 30 allows for the support plate 40 secured to an upper surface of pivoting member 30, to be rotated relative to the base 20. As illustrated, an optional cushioned or slip resistant mat 42 to be secured to an upper surface of the support plate 40. Appropriate edge guards can be placed along exposed edges that may be present on the support plate. As illustrated, conventional screws and bushings will allow the components seen in reference to FIG. 1A to be secured together in a manner facilitates the rotation of the component parts. As additionally seen in the figures, the base 20 can have rubber pads placed on the bottom of the base to provide stability and also to provide an elevated height that allows the foot pedal to be engaged and disengaged with sufficient clearance such that a floor substrate does not interfere with operation of the pedal. When the pedal is depressed, a pin 52 will disengage from an aperture 54 of the support plate 40 allowing the support plate 40 to rotate, along with the pivoting member 30 to a second engaged position. The compression spring associated with the pin 52 will serve to automatically engage the pin 52 into the corresponding aperture 54 of the support plate 40 when the pin 52 and aperture 54 line up. As illustrated, the lower surface of base 20 is adapted for securing the foot pedal 50 using a plunger guide plate and associated bottom braces which can be secured by a cutter pin. It is understood that any number of conventional pedal release mechanisms that allow for a secured pin to be removed from an aperture and reinserted into a new aperture formed in an overhead support plate 40 can be utilized. Additional details of the securement of the foot pedal 40 to the brace plates and support channels are seen in reference to FIG. 3.

In operation, the support stand 10 allows a process of supporting a person on the support plate 40. By depressing the foot pedal 50, the support plate 40 and the supported individual can be rotated to a second position where the locking pin 52 will automatically engage appropriate aperture 54. In this manner, an individual can be repositioned to make various activities and task easier and safer to perform including getting in and out of a chair or seat, a vehicle, a shower/bath tub area, a toilet, and other activities where an individual with limited ability to turn or position themselves can use the support stand to be placed into a new position for the purposes of sitting or standing.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A rotating support structure comprising:
a base;
a pivot supported by the base and in further communication with a platform, the platform supported by an upper surface of the pivot;
a pedal secured within the base and coupled to a release pin that extends above the base, the pin being adapted to engage an aperture defined by the platform;
wherein when the pedal is actuated, the pin disengages from the aperture allowing the platform to rotate from a first position and the pin to thereafter engage a second aperture within the platform thereby, securing the platform into a locked positioned.

2. The rotating support structure according to claim 1 wherein a handle is supported by the platform, the handle being attached on opposite edge walls of the supporting platform and further defining a grip region along a horizontal handle portion that connects to the pair of vertical legs extending vertically from the platform.

3. A process of positioning an individual on a support structure comprising the steps of:
a rotational support having a base;
a pivot supported by the base and in further communication with a platform, the platform supported by an upper surface of the pivot;
a pedal secured within the base and coupled to a release pin that extends above the base, the pin being adapted to engage an aperture defined by the platform;
wherein when the pedal is actuated, the pin disengages from the aperture allowing the platform to rotate from a first position and the pin to thereafter engage a second aperture within the platform thereby securing the platform into a locked positioned;
engaging the pedal to release a pin;
turning the base from a first position to a second position, as the pedal is actuated, allowing the platform and individual to be rotated to a second position in which the platform is locked, thereby enabling a person supported on the stand to be removed from the stand in a different orientation.
